(19) United States
(12) Patent Application Publication
(10) Pub. No.: US 2026/0328220 A1
(43) Pub. Date: Oct. 22, 2026

(54) BLOWER

(71) Applicant: LG ELECTRONICS INC., Seoul (KR)

(72) Inventors: Juhyun KIM, Seoul (KR); Siyoung OH, Seoul (KR); Jaehyuk JUNG, Seoul (KR); Seokho CHOI, Seoul (KR)

(73) Assignee: LG ELECTRONICS INC., Seoul (KR)

(21) Appl. No.: 19/107,679

(22) PCT Filed: Feb. 3, 2023
(86) PCT No.: PCT/KR2023/001610

§ 371 Date: Feb. 28, 2025

(30) Foreign Application Priority Data
Jan. 2, 2023 (KR) 10-2023-0000194

(51) Int. Cl. F04D 29/44; F04D 25/06; F04D 25/08

(52) U.S. Cl. CPC F04D 29/444; F04D 25/06; F04D 25/08

(57) ABSTRACT

A blower includes a lower case having an inlet; an upper case having an outlet; and a fan assembly located in the lower case, the fan assembly including a rim; a fan disposed inside the rim and having a plurality of blades rotating around a vertical rotation axis; a hub disposed on an upper side of the fan inside the rim, separated inward in the radial direction from an inner peripheral surface of the rim, and forming a space; and a plurality of vanes extending in a radial direction to connect the rim and the hub. The space includes a first area and a second area area. The plurality of vanes include a first vane disposed in the first area and a second vane disposed in the second area. The second vane has an entrance angle that is larger than an entrance angle of the first vane.

### CROSS REFERENCE TO RELATED APPLICATIONS

This application is the National Phase of PCT International Application No. PCT/KR2023/001610, filed on Feb. 3, 2023, which claims priority under 35 U.S.C. 119(a) to Patent Application No. 10-2023-0000194, filed in the Republic of Korea on Jan. 2, 2023, all of which are hereby expressly incorporated by reference into the present application.

### TECHNICAL FIELD

The present disclosure relates to a blower that discharges air through the Coanda effect and specifically, to a blower equipped with a diffuser corresponding to an internal flow path.

### BACKGROUND ART

A blower refers to a device equipped with an inlet and an outlet, having a blower fan disposed inside and discharging air pulled in through the inlet to the outside through the outlet. At this time, it is known that a proper configuration of the blower's internal space (or internal air flow path) is directly related to the energy efficiency (vibration and noise levels, power efficiency, and so on) of the blower as well as the blowing performance of the blower.

In general, the blower is equipped with a diffuser at the downstream portion of the blower fan so that the air discharged from the blower fan flows smoothly toward the outlet. A diffuser is a device designed to enhance static pressure by reducing the speed of the fluid and guide the fluid in a desired direction through vanes designed to deliberately introduce flow resistance. In other words, the diffuser in the blower is a device that enables the air discharged by the blower fan to pass through the vanes and to flow toward the outlet.

In the conventional blowers disclosed in the Chinese Patent Publications No. 111156623 A and No. 107023884 A, when the diffuser is provided downstream of the fan, the air flow path formed by the diffuser generates a uniform, concentric ring shape around the rotation axis of the fan.

However, the internal space of the blower typically lacks radial symmetry with respect to the rotation axis of the fan. For example, an asymmetrical structure may be disposed only on one side of the internal space of the blower, or the blower may be provided with a tower-shaped outlet rather than a ring-shaped outlet. Since the diffuser is formed uniformly in a circular shape despite the asymmetry of the blower's internal space around the rotation axis, the conventional blower exhibits a decrease in the internal flow efficiency, resulting in reduced blowing performance.

Suppose the flow path width of the diffuser is adjusted to accommodate the internal space of the blower, which is asymmetric with respect to the rotation axis; however, if the vanes provided within the diffuser for directing the flow are uniformly and radially symmetrical, the blower's internal flow efficiency still decreases.

Also, conventional blowers commonly employ a diffuser that is integrally formed through injection molding; in this case, the diffuser's shape may not adequately accommodate structural change such as upgrading internal components or installing new components such as heaters or speakers inside the blower.

Also, since conventional blowers generally have a structure in which components are stacked from the lower side to the upper side, with a diffuser disposed among them, the load above the diffuser is concentrated on the diffuser; however, as the diffuser is formed solely by connecting the outer periphery and the inner periphery using thin vanes without a separate reinforcement structure for dispersing the load, it is likely that durability of the diffuser may be reduced.

### DISCLOSURE

### Technical Problem

An object of the present disclosure is to solve the technical problem above.

Another object of the present disclosure is to provide a blower with enhanced blowing performance by employing a diffuser capable of accommodating the shape of the blower's internal flow path.

Yet another object of the present disclosure is to provide a blower in which a diffuser may safely fulfill both the flow guiding and load bearing functions even in a structure in which the load of the upper portion is concentrated on the diffuser.

Still another object of the present disclosure is to provide a blower with better blowing performance by simply modifying an existing diffuser and disposing the modified diffuser.

Yet still another object of the present disclosure is to provide a blower capable of maintaining excellent blowing performance despite a change in the internal flow path by employing a diffuser capable of accommodating structural components which may be disposed while the blower is in use.

Other technical objects of the present disclosure are not limited to those described above. Other technical objects not mentioned above may be understood clearly by those skilled in the art from the descriptions given below.

### Technical Solution

A blower according to an embodiment of the present disclosure comprises a lower case in which an inlet is formed; an upper case in which an outlet is formed and which is disposed on the upper side of the lower case; a rim disposed inside the lower case and including a fan assembly that pressurizes air introduced through the inlet and directs the pressurized air toward the outlet, wherein the fan assembly is open in the vertical direction and forms a periphery; a fan disposed inside the rim and having a plurality of blades rotating around a vertical rotation axis; a hub disposed on the upper side of the fan inside the rim, separated inward in the radial direction from the inner peripheral surface of the rim, and forming a space Vp through which air discharged from the fan flows; and a plurality of vanes extending in the radial direction to connect the rim and the hub and disposed along the peripheral direction, wherein the space Vp includes a first area and a second area of which the separation distance between the hub and the rim in the radial direction is larger than the first area; the plurality of vanes include a first vane disposed in the first area and a second vane disposed in the second area; and the second vane has an entrance angle, which is the degree of inclination of a lower end portion with respect to the vertical direction, larger than the entrance angle of the first vane.

Accordingly, when a diffuser is formed, a relatively wide flow path is formed in the area suitable for the flow of discharge flow, and in response to the widening of the flow path, vanes are shaped to increase the entrance angle so that the vanes may actively guide the flow; by doing so, air volume of the blower may be increased, and the noise of the blower may be reduced.

For example, the width of the second area may be 1.1 to 1.3 times wider than the width of the first area, and the entrance angle of the second vane may be 2 to 4 degrees larger than the entrance angle of the first vane.

For example, the size of the second area is 1% to 3% larger than the size of the first area, and the entrance angle of the second vane may be 2 to 4 degrees larger than the entrance angle of the first vane.

For example, the size of the second area may be 2.5% larger than the size of the first area, and the entrance angle of the second vane may be 3 degrees larger than the entrance angle of the first vane.

The upper case of a blower according to an embodiment of the present disclosure may include a first tower in which a first discharge space Vo1 into which air discharged from a fan is introduced and a first outlet are formed; a second tower separated from the first tower and in which a second discharge space Vo2 into which air discharged from the fan flows and a second outlet are formed; and a tower base disposed between the first tower, second tower, and lower case and forming a distribution space Vd from which air discharged from the fan is distributed to the first discharge space and the second discharge space. At this time, the second area may be formed in at least a portion of the area corresponding in the vertical direction to the first discharge space Vo1 and the second discharge space Vo2 within the space Vp.

Accordingly, by considering the straightness of flow of air discharged upward from the fan and maximizing the proportion of air reaching the outlet through the optimal path, the air volume of the blower may be further increased, and noise may be further reduced.

In the tower base of the blower according to an embodiment of the present disclosure, a portion of the periphery may intrude inward, and a predetermined first structure is disposed; and the second area may be formed in at least a portion of the area corresponding in the vertical direction to the first structure within the space Vp.

Accordingly, even if the air flow path narrows downstream of the fan assembly due to a structure disposed to add a predetermined function to the blower, more air may be made to flow in the area corresponding to the narrowed flow path among the flow paths in the diffuser, thereby maintaining the uniformity of flow even with a structure intruded into the flow path.

The rim and the hub on a planar cross-section of the blower according to an embodiment of the present disclosure may have ring shapes similar to each other, and the hub may include a recessed portion in which a portion of the periphery of the hub is recessed to the inside of the radius to define the second area.

Accordingly, the rim and the hub of the diffuser may be provided to suit the volume of the blower, but only the hub may be recessed inward to form the second area; thus, the second area may be easily provided without affecting the overall shape of the blower.

The recessed portion in the hub of the blower according to an embodiment of the present disclosure may have a planar shape.

Accordingly, it is possible to manufacture a hub with a recessed portion by simply inserting a mold produced by flat pressing into the manufacturing mold of an existing ring-shaped hub, thereby improving the manufacturability of the blower.

In a plurality of vanes of the blower according to an embodiment of the present disclosure, the separation distance between adjacent vanes may be greater in the second area than in the first area.

Accordingly, the air volume of the blower may be increased, and noise of the blower may be reduced by reducing flow resistance due to the vanes in the area with a widened flow path by adjusting the spacing between vanes in response to the widening of the flow path of the diffuser in different amounts for the respective areas.

The interior of the hub of the blower according to an embodiment of the present disclosure may be hollow to house a fan motor therein, and the blower may further include a wire case in which a wire that supplies power to the fan motor is disposed, wherein the wire case may extend in the radial direction between the rim and the hub, and the wire case may be disposed in the second area.

Accordingly, the wire case that is thicker than the vane and protects the wire, which is inevitably provided for the operation of the fan motor, from moisture or water drops inside may be formed not in the first area but in the second area with a relatively wide flow path, thereby mitigating the reduction of flow efficiency due to the wire case.

According to an embodiment of the present disclosure, a predetermined second structure may be disposed on the rim of the blower as a portion of the periphery is intruded inward, and the first area may include a 1-1 area and a 1-2 area into which the second structure is intruded to make the radial separation distance between the hub and the rib narrower than in the 1-1 area, wherein the first vane may include a 1-1 vane disposed in the 1-1 area and a 1-2 vane disposed in the 1-2 area, and the 1-2 vane may have a smaller entrance angle than the 1-1 vane.

Accordingly, when the width of a flow path of a pressurized space is narrowed by a structure intruded into the pressurized space, the flow may be prevented from being concentrated in the narrowed area by reducing the entrance angle of the vane in the corresponding area.

The lower end of the second vane of the blower according to an embodiment of the present disclosure may be bent and extended to form an entrance angle, and the length of the lower end may be longer than that of the first vane.

Accordingly, the flow guide effect may be further improved by enlarging the guide area while increasing the entrance angle.

The second vane of the blower according to an embodiment of the present disclosure may be formed by rotating the first vane so that the entrance angle is larger than that of the first vane.

Accordingly, the mold for the second vane may be obtained by simply rotating the existing mold used for the first vane, thereby improving the convenience of mold manufacturing.

Specifics of other embodiments are included in the detailed descriptions and appended drawings.

### Advantageous Effects

According to the present disclosure, in a predetermined area of the diffuser, the width of the flow path is widened, and the entrance angle of a vane is formed differently according to the corresponding vane; therefore, asymmetry of the flow path inside the blower (e.g., an intrusion member disposed downstream of the diffuser or a non-annular shape of the blower outlet) may be compensated, and a uniform air volume may be obtained over the entire area of the outlet, thereby improving the blowing performance and noise performance of the blower.

According to the present disclosure, the blowing performance and noise performance of the blower may be improved by adjusting the number of vanes and the distance between the vanes in response to different flow path widths within the diffuser.

According to the present disclosure, in a blower with a structure that requires stable transfer of the load from the upper part of the blower to the lower part thereof (particularly, in the form of twin towers separated from each other), the structural rigidity of the diffuser may be reinforced by differentiating the lengths and/or spacings of the vanes when the load of the upper part of the blower is transferred to the external housing through the diffuser.

According to the present disclosure, the entrance angles and/or spacings of the vanes may be easily differentiated by adopting a groove-fitting method to fasten the diffuser and the vanes and enabling rotation by an external force at a predetermined level; therefore, even if a blower user may modify the internal structure of the blower by adding options, the change in the internal structure may be easily accommodated.

The technical effects of the present disclosure are not limited to the technical effects described above, and other technical effects not mentioned herein may be understood clearly to those skilled in the art from the description of the appended claims.

### DESCRIPTION OF DRAWINGS

FIG. 1 is a perspective view of a blower according to an embodiment of the present disclosure.

FIG. 2 is an exemplary view illustrating the operation of FIG. 1.

FIG. 3 is a front view of FIG. 2.

FIG. 4 is a top view of FIG. 3.

FIG. 5 is a cross-sectional view of the right side of FIG. 2.

FIG. 6 is a front cross-sectional view of FIG. 1.

FIG. 7 is a cross-sectional perspective view of FIG. 1.

FIG. 8 is a plan view cut along line VIII-VIII of FIG. 3.

FIG. 9 is a bottom view cut along line IX-IX of FIG. 3.

FIG. 10 is a plan view cut along line X-X of FIG. 3.

FIG. 11 is an exemplary diagram showing the horizontal airflow of a blower according to an embodiment of the present disclosure.

FIG. 12 is an exemplary diagram showing the upward airflow of a blower according to an embodiment of the present disclosure.

FIG. 13 is a magnified view of TA portion of FIG. 5.

FIG. 14 is a perspective view of a diffuser for a blower according to an embodiment of the present disclosure.

FIG. 15 is a top view of FIG. 14.

FIG. 16 is a perspective view of a vane provided in a diffuser for a blower according to an embodiment of the present disclosure.

### MODE FOR DISCLOSURE

The advantages and features of the present disclosure, and a method for achieving them will be clearly understood with reference to the embodiments described in detail together with appended drawings. However, the technical principles and spirit of the present disclosure are not limited to the embodiments disclosed below but may be implemented in various other forms; rather, the present embodiments are provided to make the present disclosure complete and clearly inform those skilled in the art of the technical scope of the present disclosure, and the technical principles and spirit of the present disclosure may be defined within the technical scope of the appended claims. Throughout the document, the same reference symbols refer to the same constituting elements.

In what follows, unless otherwise stated, “upstream” and “downstream” may mean upstream and downstream of the air flow within the blower 1. In what follows, without further explanation, it may be described on the assumption that the inlet 155, fan 320, diffuser 340, and outlet are disposed from the lower side to the upper side. However, the specific arrangement is only for the convenience of description, and the gist of the present disclosure should be understood based on whether the arrangement is upstream or downstream with respect to the direction of air flow, and it should not be understood that the gist of the present disclosure limited by whether the arrangement is left, right, up, or down. For example, when the inlet 155 is disposed on the upper side of the diffuser 340 and the outlet is disposed on the lower side of the diffuser 340, the flow path width of the diffuser 340 may be determined by considering the space below the diffuser 340.

In what follows, descriptions may be given based on the assumption that the hub 344 of the diffuser 340 serves as a motor housing for accommodating a fan motor 310. However, the technical principles of the present disclosure are not limited by the assumption, and it should be understood that the gist of the present disclosure lies in technical details related to the air flow of the diffuser 340. For example, the fan motor 310 may be connected to the upstream end of the fan 320, and the diffuser 340 may be disposed at the downstream end of the fan 320.

Meanwhile, the radial direction according to the present disclosure refers not only to the direction of a straight line extending from the center of a circle to its circumference but also to the direction of a straight line extending from the center to the periphery for all shapes with defined centers and peripheries. The radial direction may mean a radial direction with respect to the center of the planar cross-section of the blower 1. In other words, it may not necessarily mean that the planar cross-sectional shape of the blower 1 should be circular. In what follows, terms such as ‘circumferential direction’, ‘rotational direction’, ‘radial inner direction’, and ‘radial outer direction’ may also be used in the same manner as above.

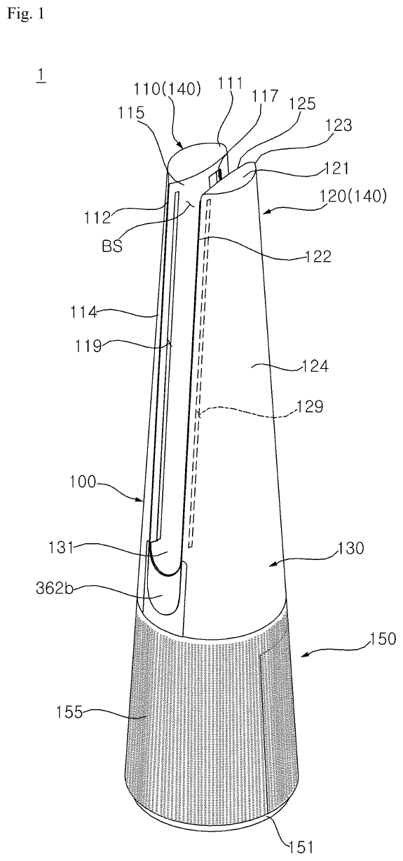

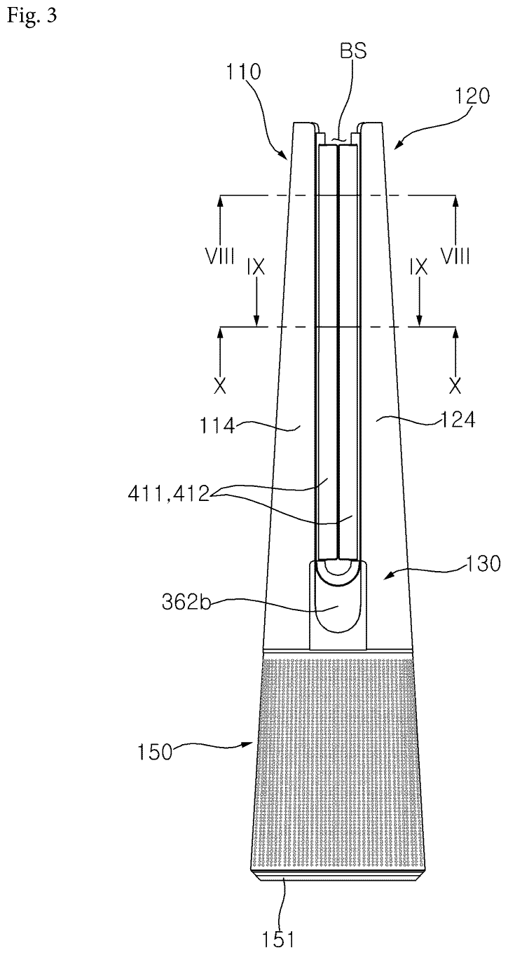

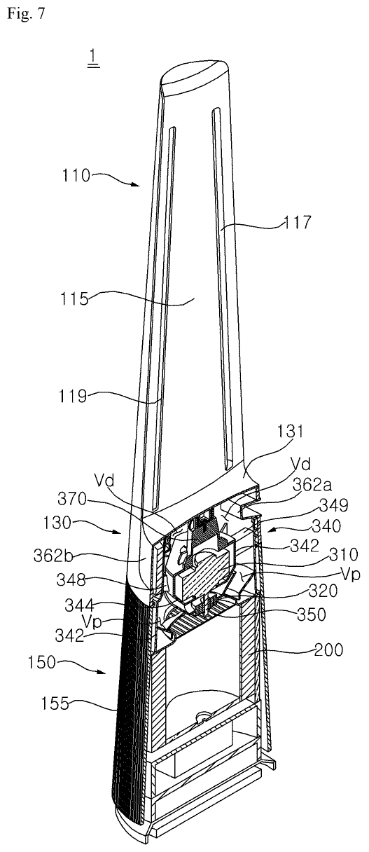

In what follows, with reference to FIGS. 1 to 7, the case 100 of the blower 1 according to an embodiment of the present disclosure will be described.

The case 100 may constitute the external appearance of the blower 1. The case 100 may be provided with an inlet 155 and an outlet 117, 127.

The case 100 may include a lower case 150, a tower base 130, and an upper case 140. The lower case 150 may constitute the lower part of the blower 1. The upper case 140 may constitute the upper part of the blower 1. The tower base 130 may be disposed between the lower case 150 and the upper case 140 to form the central part of the blower 1. The tower base 130 may be regarded as constituting a portion of the upper case 140.

An inlet 155 is formed in the lower case 150. The inlet 155 may be formed by creating an opening along the periphery of the lower case 150. The inlet 155 may be disposed along the periphery of the lower case 150. Therefore, air surrounding the lower case 150 may be uniformly drawn in from 360 degrees.

An outlet is formed in the upper case 140. The outlet 117, 127 may be formed by creating an opening along the periphery of the upper case 140.

The upper case 140 is disposed above the lower case 150. Inside the upper case 140, a discharge space Vo may be formed, through which air flows toward the outlet 117, 127. The discharge space Vo may be regarded as the internal space of the upper case 140.

The upper case 140 may include a first tower 110 and a second tower 120 (see FIG. 1).

The first tower 110 and the second tower 120 may be in the form of two pillars. In the present embodiment, the first tower 110 may be disposed on the left, and the second tower 120 may be disposed on the right. The upper case 140 including the first tower 110, the second tower 120, and the blowing space BS therebetween may be formed in a truncated cone shape.

The first tower 110 may be provided with a first outlet 117. The first tower 110 may form a first discharge space Vo1 through which air discharged from the fan 320 is drawn in and directed toward the first outlet 117. The first outlet 117 may be formed by opening the first tower 110. The first discharge space Vo1 may be regarded as the internal space of the first tower 110. Air flowing in the first discharge space Vo1 may be discharged through the first outlet 117. The first tower 110 may have a cylinder or truncated cone shape.

The first tower 110 may be in the form of an elongated tower extending upward. The first outlet 117 may also extend along the longitudinal direction of the first tower 110. However, the technical principles of the present disclosure are not limited by the specific shape of the first tower 110, and the technical principles of the present disclosure may be applied irrespective of the specific shape in which the first tower 110 is formed.

The second tower 120 may be provided with a second outlet 127. The second tower 120 may form a second discharge space Vo2 through which air discharged from the fan 320 is drawn in and directed toward the second outlet 127. The second outlet 127 may be formed by opening the second tower 120. The second discharge space Vo2 may be regarded as the internal space of the second tower 120. Air flowing in the second discharge space Vo2 may be discharged through the second outlet 127. The second tower 120 may have a cylinder or truncated cone shape. The second tower 120 may be in the form of an elongated tower extending upward. However, the technical principles of the present disclosure are not limited by the specific shape of the second tower 120, and the technical principles of the present disclosure may be applied irrespective of the specific shape in which the second tower 120 is formed.

The second tower 120 may be separated from the first tower 110. Specifically, the second tower 120 may be laterally separated from the first tower 110 to form a blowing space BS therebetween. The blowing space BS may be regarded as a space in which air discharged from the first outlet 117 and the second outlet 127 flows. The outlet 117, 127 may discharge air into the blowing space BS. In the present embodiment, the blowing space BS may be open at the front, rear, and/or top.

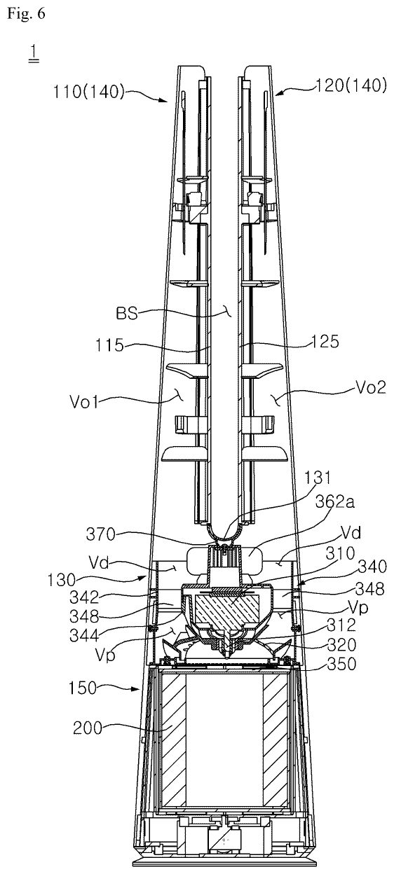

The first discharge space Vo1 and the second discharge space Vo2 may each be coupled to the distribution space Vd of the tower base 130, respectively. Specifically, each of the first discharge space Vo1 and the second discharge space may be connected to the tower base 130 in series, and the first discharge space Vo1 and the second discharge space Vo2 may be parallel with each other. The air discharged from the diffuser 340 may pass through the distribution space Vd and be distributed into the first discharge space Vo1 and the second discharge space Vo2, respectively (see FIG. 6).

The first tower 110 and the second tower 120 may be symmetrical to each other based on the blowing space BS formed therebetween. The first outlet 117 and the second outlet 127 may be symmetrical to each other.

The tower base 130 may be disposed between the lower case 150 and the upper case 140. The tower base 130 may be disposed between the first tower 110, the second tower 120, and the lower case 150. The tower base 130 may form a distribution space Vd that connects the pressurizing space Vp, which will be described later, with the discharge space Vo of the upper case 140. The tower base 130 may form a distribution space Vd in which the air discharged from the fan 320 is distributed into the first discharge space Vo1 and the second discharge space Vo2. The distribution space Vd may be regarded as the internal space of the tower base 130. The tower base 130 may be regarded as a part of the upper case 140. Alternatively, the tower base 130 may be regarded as a part of the lower case 150.

The downstream end of the lower case 150 may be the downstream end of the pressurized space Vp of the diffuser 340. The upstream end of the distribution space Vd may be connected to the pressurized space Vp. The downstream end of the distribution space Vd may be connected to the discharge space Vo. The pressurized space Vp, distribution space Vd, and discharge space Vo may constitute a continuous space.

The lower end of the tower base 130 may be connected to the upper end of the lower case 150. The upper end of the tower base 130 may be connected to the lower end of the upper case 140. In both external and internal appearances, the lower case 150, tower base 130, and upper case 140 may form a continuous surface.

Air discharged from the diffuser 340 (or pressurized space Vp) may be supplied to the discharge space Vo through the distribution space Vd. The tower base 130 may connect lower parts of the first tower 110 and the second tower 120, which will be described later.

Meanwhile, the fan assembly 300 is disposed inside the lower case 150. The fan assembly 300 pressurizes the air drawn in through the inlet 155 and directs the pressurized air toward the outlet. The fan assembly 300 includes a fan 320 and a diffuser 340 (i.e., a rim 342, a hub 344, and a plurality of vanes 348). The fan assembly 300 may further include a fan motor 310.

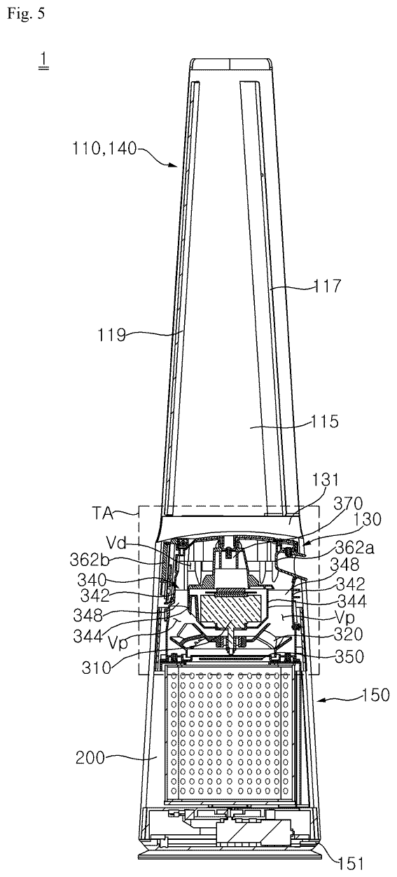

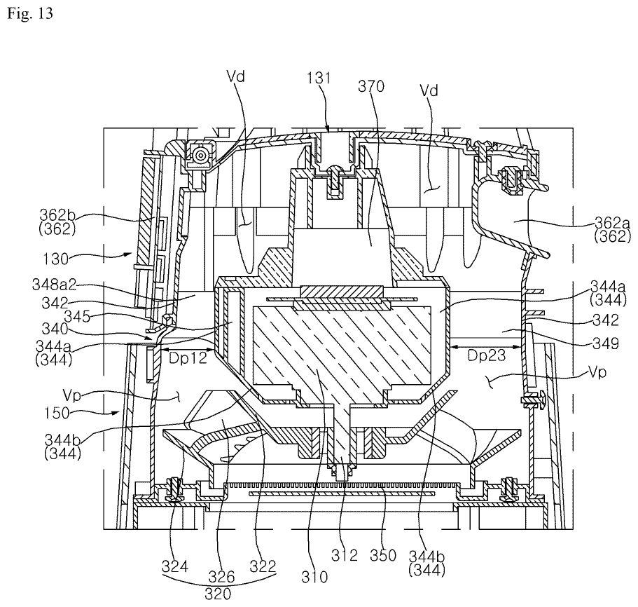

In what follows, the fan 320 will be described specifically with reference to FIGS. 5 to 7 and FIG. 13.

The fan 320 may pressurize the air flowing into the inlet 155 and direct the pressurized air toward the outlet 117, 127. As the fan 320 is disposed in the lower case 150, the air discharge direction of the fan 320 may be upward.

The fan 320 may be disposed inside the lower case 150. The fan 320 is disposed inside the rim 342 of the diffuser 340, which will be described later. The fan 320 may be disposed above the filter 200. The fan 320 may direct air that has passed through the filter 200 to the first tower 110 and the second tower 120. The fan 320 may be rotated by the fan motor 310.

The fan motor 310 may be disposed adjacent to the fan 320, and the motor shaft 312 of the fan motor 310 may be coupled to the fan 320. The fan motor 310 may be disposed above the fan 320. The fan motor 310 may be accommodated in the hub 344 of the diffuser 340, which will be described later.

The hub 344 may be shaped to surround the entire fan motor 310. Since the hub 344 surrounds the entire fan motor 310, the flow resistance of the air flowing from the lower side to the upper side and the fan motor 310 may be reduced.

However, as described above, the hub 344 of the diffuser 340 accommodates the fan motor 310 only to enhance space efficiency of the blower 1, and it should not be understood that the above structural arrangement limits the gist of the present disclosure.

Preferably, the type of fan 320 may be a mixed flow fan 320 to reduce noise and vibration of the blower 1 and ensure blowing performance. The flow fan 320 is characterized to draw air toward the center of the axis and discharges air in the radial direction, where the discharged air is inclined with respect to the axial direction. Because the overall air flow moves from the lower side to the upper side, if air is discharged in the radial direction as with a typical centrifugal fan 320, a significant flow loss due to the change in the flow direction may occur. However, the gist of the present disclosure is not limited by the type of the fan 320, and for the sake of convenience, descriptions below will be based on the use of the mixed flow fan 320.

The fan 320 may include a first shroud 322, a second shroud 324, and a plurality of blades 326.

The first shroud 322 may be formed in a downward-concave bowl shape. The second shroud 324 may have a downward-concave bowl shape. The first shroud 322 and the second shroud 324 may be disposed being separated from each other in the vertical direction.

The motor shaft 312 of the fan motor 310 may be coupled to the central portion of the first shroud 322. The central portion of the second shroud 324 may be open to allow air that has passed through the filter to move in. The space formed by the first shroud 322 and the second shroud 324 being separated from each other may be regarded as an air flow path.

A plurality of blades 326 may be disposed between the first shroud 322 and the second shroud 324. The plurality of blades 326 may connect the first shroud 322 and the second shroud 324. The plurality of blades 326 rotate around a vertical rotation axis.

As the fan motor 310 operates, the plurality of blades 326, the first shroud 322, and the second shroud 324 may rotate as one unit. The air flowing into the air inlet of the fan 320 formed by the second shroud 324 may be pressurized by the plurality of rotating blades 326 while passing through the flow path between the first shroud 322 and the second shroud 324. The space between the downstream end of the first shroud 322 and the downstream end of the second shroud 324 may be regarded as an air outlet of the fan 320. The air outlet of the fan 320 may be connected to the pressurized space Vp of the diffuser.

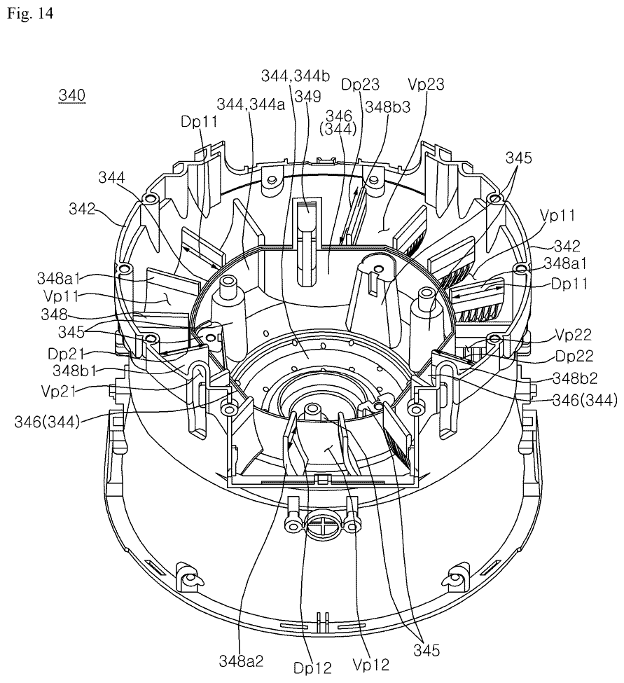

In what follows, the diffuser 340 will be described with reference to FIGS. 5 to 7 and FIGS. 13 to 16.

The diffuser 340 may reduce the radial velocity component and enhance the upward velocity component in the air flow. The diffuser 340 may guide the air discharged from the fan 320 toward the outlet 117, 127. The diffuser 340 may improve flow efficiency by changing the flow direction of air toward the outlet 117, 127.

The diffuser 340 may be disposed at the downstream end of the lower case 150. The internal space of the diffuser 340 is a space where the air discharged from the blower fan 320 is pressurized and directed upward and may be referred to as a pressurized space Vp.

The diffuser 340 may include a rim 342 forming a periphery; a hub 344 separated inward from the rim 342 to form a pressurized space Vp through which air discharged from the fan 320 flows; and a plurality of vanes 348 that extend in the radial direction between the rim 342 and the hub 344 to change the flow direction of air to the upward direction.

The rim 342 is open both at the top and bottom and forms the periphery. The rim 342 may have a cylindrical shape with open upper and lower surfaces.

The hub 344 may form a periphery narrower than the rim 342 and may be disposed inside the rim 342. The hub 344 is separated inward from the inner peripheral surface of the rim 342 in the radial direction to form a pressurized space Vp through which air discharged from the fan 320 flows. The periphery of the hub 344 may be disposed to be approximately parallel with the periphery of the rim 342.

The hub 344 is disposed on the upper side of the fan 320 inside the rim 342. In other words, the hub 344 may be formed to be shorter than the rim 342, and the fan 320 may be disposed inside the rim 342 at an upstream portion of the hub 344. Inside the rim 342, the fan 320 and the hub 344 may be arranged in the vertical direction. The hub 344 may be disposed above the fan 320. Each of the fan 320 and the hub 344 may face the rim 342. The vertical length of the hub 344 may be close to the vertical length obtained by subtracting the vertical length of the fan 320 from the vertical length of the rim 342.

Also, the hub 344 may accommodate a fan motor 310 therein, which provides a driving force to the fan 320. The fan motor 310 accommodated inside the hub 344 may be connected to the fan 320 through the motor shaft 312 penetrating one side of the hub 344. The motor shaft 312 of the fan motor 310 may be connected to the rotation axis of the fan 320. By housing the fan motor 310 inside the hub 344, the space efficiency of the blower 1 may be improved. Accordingly, the rim 342 may be regarded as the housing of the fan assembly 300.

The hub 344 may include a first part 344a whose planar cross-sectional area is uniform in the vertical direction and a second part 344b whose planar cross-sectional area becomes narrower toward the lower side. The first part 344a may constitute the upper part of the hub 344. The second part 344b may constitute the lower part of the hub 344.

The first part 344a and the second part 344b may form a continuous surface. The lower end of the first part 344a and the upper end of the second part 344b may form a continuous surface. In other words, the second part 344b may have a shape obtained by inward bending and extending of the lower end of the periphery of the first part 344a.

The first part 344a may have a cylindrical shape. The periphery of the first part 344a may be parallel with the rim 342. Vanes 348, which will be described later, may be connected to the outer periphery of the first part 344a. The fan motor 310 may be accommodated inside the first part 344a by being separated from the inner periphery of the first part 344a.

The second part 344b may extend obliquely inward in the radial direction from the lower end of the first part 344a toward the rotation axis of the fan 320. The second part 344b may have a cone shape, tapering in cross-section toward the lower side. The second part 344b may contact and support the edge of the lower end of the fan motor 310 from the inside. The second part 344b has an opening in the lower part thereof, through which the motor shaft 312 of the fan motor 310 may pass. The motor shaft 312 passing through the opening of the second part 344b may be connected to the rotation axis of the fan 320.

From the area where the fan motor 310 and the fan 320 are close enough to be connected to the motor shaft 312, the second part 344b may extend inward horizontally in the radial direction. The fan motor 310 may be mounted on the upper side of the horizontally extending portion. The central portion of the horizontally extending portion is open so that the motor shaft 312 can pass through. However, the gist of the present disclosure is not limited to whether or not the hub 344 accommodates the motor, and it should be clearly understood that the motor housing, which accommodates the fan motor 310, and the hub 344 may be configured separately.

Depending on the shape of the hub 344, the width of the pressurized space Vp may increase as it goes upward from the outlet of the fan 320 and then remain constant.

A plurality of vanes 348 of the diffuser 340 extend in the radial direction, connect the rim 342 and the hub 344, and are disposed along the peripheral direction. The plurality of vanes 348 may be separated from each other and disposed along the outer periphery of the hub 344 and the inner periphery of the rim 342. The vanes 348 of the diffuser 340 may guide the air discharged from the blower fan 320 in the upward direction and may prevent the air that has passed through the diffuser 340 from flowing back toward the blower fan 320. In particular, the vane 348 may be disposed in a section (i.e., a section corresponding to the first part 344a of the hub 344) where the width of the pressurized space Vp is narrowed and the flow speed becomes relatively high, thereby preventing a vortex and actively guiding the air flow.

As described above, the pressurized space Vp may be regarded as the space between the rim 342 and the hub 344. The pressurized space Vp may typically have a ring shape in a planar view. The air discharged from the fan 320, which has a ring-shaped outlet in a planar view, may flow in the pressurized space Vp and then be discharged from the diffuser 340. In what follows, the pressurized space Vp may be referred to as the ‘flow path of the diffuser 340.’

The inlet (to the upstream end) of the pressurized space Vp of the diffuser 340 may be connected to the outlet of the fan 320, allowing the air discharged from the fan 320 to be supplied to the diffuser 340. The outlet (or downstream end) of the pressurized space Vp of the diffuser 340 may be connected to the distribution space Vd of the tower base 130, allowing the air discharged from the diffuser 340 to be supplied to the tower base 130. The outlet of the diffuser 340 may be regarded as a portion where a plurality of vanes 348 are disposed.

The flow path width of the pressurized space Vp may be regarded as a radial separation distance Dp between the rim 342 and the hub 344. In the case of a diffuser of the conventional blower, the rim and the hub are each formed in a cylindrical shape, and the separation distances for all rotation radii are generally the same. Also, the separation distance between the hub and the rim of the conventional diffuser, which does not deliberately expand or reduce the separation distance, typically corresponds to the width of the outlet of the fan. This structural configuration is intended to ensure that the air discharged from the fan may completely pass through the diffuser.

On the other hand, according to the present disclosure, the rim 342 and the hub 344 may be formed so that the radial separation distance Dp between the rim 342 and the hub 344 varies in different areas.

By forming the separation distance Dp differently in a predetermined area, parameters such as volume and pressure of air flow passing through the diffuser 340 may be adjusted differentially. Therefore, in the area where air is discharged through a flow path of the diffuser 340 to a portion with high flow resistance within the blower 1, the radial separation distance Dp between the rim 342 and the hub 344 may be increased to expand the pressurized space Vp; thus, the performance of the blower 1 may be improved by correcting the asymmetry of the internal flow path of the blower 1 and ensuring a uniform air volume across the entire area of the outlet.

Specifically, the pressurized space Vp includes a first area Vp1 and a second area Vp2 whose separation distance Dp is greater than that of the first area Vp1. The first area Vp1 may refer to an area with a relatively short separation distance. Alternatively, the first area Vp1 may refer to an area in which the separation distance Dp is not extended further than in other areas of the pressurized space Vp. The second area Vp2 may refer to an area where the separation distance Dp is extended further than in other areas of the pressurized space Vp. The second area Vp2 may be a relative concept determined through comparison with other areas. At this time, for example, the separation distance Dp of the first area Vp1 may be referred to as the first separation distance Dp1, and the separation distance Dp of the second area Vp2 may be referred to as the second separation distance Dp2.

The second area Vp2 may be formed in at least a portion of the area corresponding in the vertical direction to the first discharge space Vo1 and the second discharge space Vo2 in the pressurized space Vp. The second area Vp2 may refer to a specific area of the pressurized space Vp of the diffuser 340 to which air to be flown straightforwardly (or in an almost straightforward manner) to the first discharge space Vo1 or the second discharge space Vo2 among the air discharged from the diffuser 340 is discharged. The second area Vp2 may be regarded as a virtual area (i.e., orthogonally projected area) defined by vertically projecting the first discharge space Vo1 and the second discharge space Vo2 onto the pressurized space Vp of the diffuser 340. The air discharged from the second area Vp2 may pass through the distribution space Vd without experiencing particular resistance due to the straightness of the air flow and may flow directly into the first discharge space Vo1 or the second discharge space Vo2.

Specifically, the projected area, in which a specific configuration is orthogonally projected into the pressurized space Vp, may refer to a specific area of the pressurized space Vp of the diffuser 340, to which air to be flown to the specifically configured portion is discharged, assuming the straightness of the air flow, which may be regarded as being discharged from the blower fan 320 and flowing straightforwardly.

On the other hand, the air discharged from the first area Vp1 may experience flow resistance until it reaches the discharge flow path. In particular, the air discharged from the first area Vp1 may move through the distribution space V in a nearly straight path; as a result, the air first hits the bridge surface 131, which will be described later, changes its flow direction, and is distributed into the first discharge space Vo1 and the second discharge space Vo2.

Therefore, expanding the flow path width of the second area Vp2 to be larger than that of the first area Vp1 may result in a greater proportion of the air volume discharged from the second area Vp2 compared to the air volume discharged by the diffuser 340 per unit time; thus, internal resistance on the path through which the air flow reaches the outlet 117, 127 may be minimized.

Therefore, by maximizing the proportion of air reaching the outlet through the optimal path in consideration of the straightness of flow of the air discharged upward from the fan 320, the flow resistance within the blower 1 may be reduced, thereby further improving the air volume and decreasing the noise level.

Meanwhile, planar cross-sections of the rim 342 and the hub 344 may have ring shapes similar to each other. For example, the planar cross-sections of rim 342 and hub 344 may be circular. At this time, a portion of the rim 342 and/or the hub 344 may be bent outward or inward in the radial direction so that the radial separation distance Dp between the rim 342 and the hub 344 varies in different areas. However, the rim 342 may form the external appearance of the diffuser 340, and at this time, the diffuser 340 has to be accommodated within a limited internal space of the blower 1; therefore, the rim 342 may be provided to inscribe the case 100 of the blower 1. Therefore, preferably, when the separation distance Dp is adjusted, bending the hub 344 radially inward may be more efficient than bending the rim 342 radially outward.

The hub 344 may include a recessed portion 346 in which a portion of the periphery is recessed to the inside of the radius to define the second area Vp2. In other words, the second area Vp2 may be formed through the recessed portion 346 or a bent portion in which the hub 344 is recessed toward the inner radius. As the hub 344 is recessed toward the inner radius, the separation distance Dp between the rim 342 and the hub 344 may be increased. In this case, the rim 342 may have a circular cross-section. Alternatively, the rim 342 may have a shape corresponding to the inner peripheral surface of the lower case 150.

Therefore, while the rim 342 and the hub 344 may be provided to match the volume of the blower 1, only the hub 344 may be recessed inward to form the second area Vp2; therefore, the overall shape of the blower 1 may not be modified, but the second area Vp2 may be provided in a convenient manner. Also, compared to the case where the rim 342 is bent outward to expand the flow path of the diffuser 340, the hub 344 may be bent inward to maintain the overall volume of the diffuser 340 and easily expand the flow path of the diffuser 340, thereby improving the air volume of the blower 1.

The recessed portion 346 of the hub 344 may have a planar shape. At this time, the recessed portion 346 or the bent portion may be formed by pressing the hub 344 inward in the radial direction. In this case, the rim 342 has a circular cross-section, and the hub 344 may be formed of a plurality of arcs whose planar cross-sections are separated from each other and a chord connecting adjacent arcs.

Therefore, it is possible to manufacture the hub 344 with the recessed portion 346 by simply inserting a mold manufactured by planar pressing into the manufacturing mold for the pre-manufactured ring-shaped hub 344, thereby enhancing the manufacturability of the blower 1.

However, the gist of the present disclosure is not limited by the manufacturing process for the recessed portion 346 or the bent portion. For example, the recessed portion 346 or the bent portion may be manufactured by those methods such as thermal deformation or injection molding.

The first tower 110 and the second tower 120 of the upper case 140 may be symmetrical to each other. Accordingly, in the second area Vp2, a 2-1 area Vp21 corresponding to the first discharge space Vo1 and a 2-2 area Vp22 corresponding to the second discharge space Vo2 may be symmetrical to each other. In the second vane 348b, a 2-1 vane 348b1 disposed in the 2-1 area Vp21 and a 2-2 vane 348b2 disposed in the 2-2 area Vp22 may be symmetrical to each other.

Accordingly, the flow efficiency of the blower 1 may be optimized by synchronizing the configuration of the flow path downstream of the diffuser 340 with that of the pressurized space Vp and the vane 348.

Meanwhile, the blower 1 may further include a structure 362, at least a portion of which is intruded into the tower base 130 and is disposed on the distribution space Vd (see FIGS. 5 to 7 and FIG. 13). The structure 362 may be built to provide a specific function to the blower 1.

The structure 362 may occupy a portion of the distribution space Vd. Air flow within the distribution space Vd may be impeded by the structure 362. The structure 362 may exert resistance against the flow within the distribution space Vd. To compensate for the flow resistance within the distribution space Vd caused by the structure 362, the separation distance Dp of the flow path width of the diffuser 340 may be adjusted.

For example, a predetermined first structure 362a may be disposed as a portion of the periphery of the tower base 130 is intruded inward. The first structure 362a may be a handle that facilitates movement of the blower 1 by allowing the user to insert his or her hand into the depressed portion. The handle may be recessed inward from the outer surface of the tower base 130, and the opposite side of the recession direction may be open for connection to the external space. Since the tower base 130 is disposed on the upper side of the lower case 150, the position of the handle on the flow path in the vertical direction may be determined naturally to be above or downstream of the hub 344 or the pressurized space Vp.

The second area Vp2 having a relatively large separation distance Dp may be formed in at least a portion of the area corresponding to the first structure 362a in the vertical direction within the pressurized space Vp. To distinguish it from the 2-1 area Vp21 and 2-2 area Vp22, the area where the first structure 362a is orthogonally projected within the pressurized space Vp may be referred to as the 2-3 area Vp23. The 2-3 area Vp23 may refer to a specific area within the pressurized space Vp of the diffuser 340 to which air to be flown toward the first structure 362a is discharged.

Accordingly, even if the air flow path is narrowed downstream of the fan assembly 300 due to the arrangement of the structure 362 for adding a predetermined function to the blower 1, the separation distance Dp in the 2-3 area Vp23 is made larger than that for adjacent areas to make more air flow in the area corresponding to the narrowed flow path within the pressurized space Vp; therefore, the amount of air reaching the outlet 117, 227 out of the air passing through the 2-3 area Vp23 per unit time may be similar to the amount of air reaching the outlet 117, 227 out of the air passing through adjacent areas despite the local flow resistance caused by the first structure 362a. Accordingly, the flow efficiency inside the blower 1 and the discharge performance of the blower 1 may be improved.

Meanwhile, the structure 362 may occupy not only the distribution space Vd but also the pressurized space Vp. The flow path width of the portion of the pressurized space Vp into which the structure 362 is inserted may be narrowed by the structure 362. The air flow within the pressurized space Vp may be impeded by the structure 362. The structure 362 may exert resistance to the flow within the pressurized space Vp. To compensate for the flow resistance, the entrance angle X of the vane 348 may be adjusted, which will be described later.

For example, the second structure 362b may be a display unit that includes a display that visually displays information on the blower 1 to the user and display-related components. The display may be disposed on the outer surface of the tower base 130 and exposed to the outside. The display-related component may be an electronic substrate circuit (PCR) for display disposed by being intruded into the inside of the tower base 130 and/or the rim 342 and electrically connected to the display. In other words, a portion of the periphery of the rim 342 intrudes into the inside (i.e., intrudes into the pressurized space Vp), and at least a portion of a predetermined second structure 362b may be disposed in the intruded portion.

At this time, the first area Vp1 may include the 1-1 area Vp11 and the 1-2 area Vp12 in which the radial separation distance Dp between the hub 344 and the rim 342 is narrower than that in the 1-1 area Vp11 due to the intrusion of the second structure 362b. The 1-1 area Vp11 may refer to the first area Vp1 in which a separate intrusion structure 362 is not disposed.

As described later, the entrance angle X of the 1-2 vane 348a2 disposed in the 1-2 area Vp12 may be adjusted to compensate for the reduction of the flow path width due to the intrusion of the second structure 362b.

The radial length of the vane 348 may be equal to the separation distance Dp of a portion in which the corresponding vane 348 is disposed. As the pressurized space Vp is divided into a plurality of areas with different widths, the vanes 348 disposed in the respective areas may also be distinguished from each other.

The plurality of vanes 348 includes a first vane 348a disposed in the first area Vp1 and a second vane 348b disposed in the second area Vp2. The radial length of the first vane 348a may be equal to the separation distance Dp1 of the first area Vp1. The radial length of the second vane 348b may be equal to the separation distance Dp2 of the second area Vp2.

As the first area Vp1 is divided into the 1-1 area Vp11 and the 1-2 area Vp12, the first vane 348a may include the 1-1 vane 348al disposed in the 1-1 area Vp11 and the 1-2 vane 348a2 disposed in the 1-2 area Vp12.

As the second area Vp2 is divided into the 2-1 area Vp21 and the 2-2 area Vp22, and/or the 2-3 area Vp23, the second vane 348b may include the 2-1 vane 348b1 disposed in the 2-1 area Vp21, the 2-2 vane 348b2 disposed in the 2-2 area Vp22, and/or the 2-3 vane 348b3 disposed in the 2-3 area Vp23.

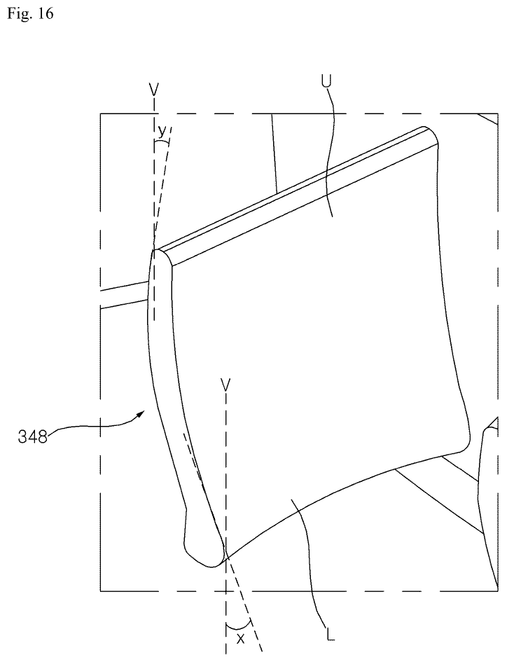

As the air flow discharged from the fan 320 mainly moves from the lower side to the upper side, the lower end portion L of the vane 348 may be regarded as the upstream end portion L of the vane 348, and the upper end portion U of the vane 348 may be regarded as the downstream end portion U of the vane 348. The angles at which the upstream end portion L and the downstream end portion U of the vane 348 are inclined with respect to a straight line V perpendicular to a virtual vertical direction may be referred to as the inlet angle X and the outlet angle Y, respectively (see FIG. 16).

In a conventional diffuser, the entrance angles of a plurality of vanes are the same. However, in the case of the blower 1 according to the present disclosure, the inlet angle X2 of the second vane 348b is formed to be larger than the inlet angle X1 of the first vane 348a.

The degree of differentiation in the entrance angle X of the vane 348 may be determined by considering the extent to which the flow path width Dp of the corresponding area is differentiated. For example, when the flow path width Dp2 of the second area is formed to be 1.1 to 1.3 times wider than the width Dp1 of the first area Vp1, the inlet angle X2 of the second vane 348b may be 2 to 4 degrees larger than the entrance angle X1 of the first vane 348a.

The degree of differentiation in the entrance angle X of the vane 348 may be determined by considering the extent to which the planar cross-section area of a flow path in the corresponding area is differentiated. For example, the size of the second area Vp2 may be 1% to 3% larger than the size of the first area Vp1. The entrance angle X2 of the second vane 348b may be 2 to 4 degrees larger than the entrance angle X1 of the first vane 348a. Specifically, the size of the second area Vp2 may be 2.5% larger than the size of the first area Vp1. The entrance angle X2 of the second vane 348b may be 3 degrees larger than the entrance angle X1 of the first vane 348a. The above numbers are experimentally derived values and may be regarded as values that maximize the improvement of flow efficiency.

As described above, the air volume of the blower 1 may be increased, and the noise of the blower 1 may be reduced by forming the flow path width of the area favorable to the flow of discharged air (i.e., the second area Vp2) to be relatively wide and modifying the shape of the vane 348 in response to the widening of the flow path width in such a way to increase the entrance angle and to actively guide the air flow.

Meanwhile, as described above, the 1-2 area Vp12 may be regarded as an area in which the flow path width is limited due to intrusion of the second structure 362b. At this time, the entrance angle X12 of the 1-2 vane 348a2 disposed in the 1-2 area Vp12 may be formed to be smaller than the entrance angle X11 of the 1-1 vane 348a1. Accordingly, when the flow path width of the pressurized space Vp is narrowed by the structure 362 intruded into the pressurized space Vp, an air flow may be prevented from being concentrated in the narrowed area by reducing the entrance angle of the vane 348 in the corresponding area.

Meanwhile, according to a method for differentiating the entrance angle X of the vane 348, for example, the lower end portion L of the vane 348 may be bent and extended further. In this case, the length of the lower end portion L of the second vane 348b, which is bent and extended to form the entrance angle X2, may be longer than that of the first vane 348a. If the above method is employed, the flow guide effect may be further improved by enlarging the guide area while increasing the entrance angle.

Alternatively, according to a method for differentiating the entrance angle X of the vane 348, for example, the vane 348 may be rotated in the counterclockwise or clockwise direction with respect to the center of a longitudinal cross-section. In this case, the second vane 348b may be formed by rotating the first vane 348a so that the entrance angle X is larger than that of the first vane 348a. If the above method is employed, the mold for the second vane 348b may be obtained by simply rotating the mold for the existing first vane 348a, thereby improving convenience in manufacturing a mold.

Meanwhile, the exit angle Y of the vane 348 may be close to 0 degrees so that the air passing through the vane 348 flows upward.

As described above, when the entrance angle of the vane is differentiated by rotating the vane, assembly of the vane may be carried out in a prefabricated manner so that the entrance angle may be adjusted flexibly through simple rotation of the vane. For example, a protrusion for fastening a vane to the rim and the hub may be formed, and a corresponding groove may be provided to the vane. At this time, the protrusion and groove may be located in the center of the vane on the longitudinal cross-section, and the protrusion and groove may be joined by a fitting method, and the vane may be formed to rotate when an external force above a predetermined level is applied. Accordingly, the entrance angle of the diffuser vane may be easily adjusted.

On the other hand, as described above, when the length of the vane in the vertical direction or flow direction is extended (i.e., the lower end portion is extended) to differentiate the entrance angle between the vanes, the length of the vane in the vertical direction may be formed to be relatively longer in the second area in which a flow path width is wide and the burden of the load to be transferred from the hub to the rim may be greater, which is advantageous in terms of reinforcing the rigidity of the diffuser in transferring the load.

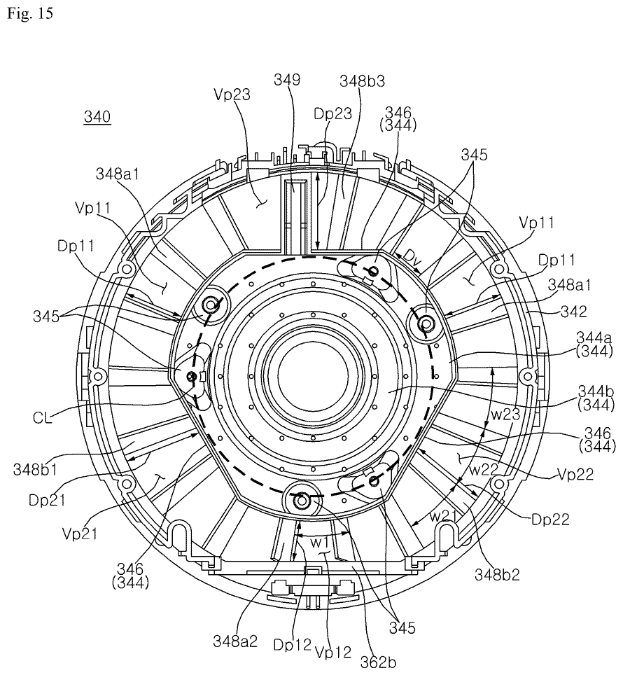

A plurality of vanes 348 may be disposed being separated from each other along the outer peripheral surface of the hub 344. A plurality of vanes 348 may be disposed to be separated from each other along the inner peripheral surface of the rim 342. At this time, the separation distance w between the vanes 348 may be regarded as a peripheral separation distance between the vanes 348. For example, the separation distance w between the vanes 348 may mean the distance in the circumferential direction from the lower end of one vane 348 to the lower end of an adjacent vane 348. The distance in the circumferential direction may be expressed in terms of a rotation angle with respect to the center of the diffuser 340 in a planar cross-section (see FIG. 15).

In the case of a conventional diffuser, a plurality of vanes are commonly disposed at equal intervals along the circumference of the hub or rim. However, when the entrance end portion of the vane 348 extends while being inclined in the counterclockwise direction on a planar cross-section to differentiate the entrance angle X of the vane 348, the distance w between vanes 348 may also be differentiated due to the length difference made by the extension of the entrance end portion. Accordingly, the separation distance w between adjacent vanes 348 of the plurality of vanes 348 may be greater in the second area Vp2 than in the first area Vp1. For example, proceeding in the counterclockwise direction, the rotation angle w21 between the vane 348 adjacent to the 2-2 area Vp22 and the 2-2 vane 348b2 closest to the vane 348, the rotation angle w22 between the two 2-2 vanes 348b2, and the rotation angle w23 between the remaining vanes 348 adjacent to the 2-2 area Vp22 and the 2-2 vane 348b2 closest thereto may be 20.05 degrees, 20.00 degrees, and 19.95 degrees, respectively.

On the other hand, apart from differentiating the entrance angle X of the vane 348, the flow of the blower 1 may be improved by more deliberately adjusting the distance w between the vanes 348. For example, the vanes 348 disposed in the second area Vp2 may be moved in parallel in the circumferential direction and disposed so that the distance w2 between them increases, and the vanes 348 disposed in the first area Vp1 may be moved in parallel in the circumferential direction and disposed so that the distance w1 between them becomes closer. Accordingly, the separation distance w between adjacent vanes 348 of the plurality of vanes 348 may be greater in the second area Vp2 than in the first area Vp1.

A plurality of grooves may be formed in the circumferential direction on the inner surface of the rim 342 and the outer surface of the hub 344. The spacing between adjacent grooves within the plurality of grooves may be uniform. The plurality of vanes 348 may be fastened to predetermined grooves among the plurality of grooves using a forced fitting method.

By allowing the vanes 348 to be selectively fastened to grooves formed at equal intervals, the separation distance between the vanes 348 in the second area Vp2 may be easily adjusted. Also, when the blower 1 is used, it is possible to easily respond to changes in the internal structure of the blower 1 due to addition of options.

As described above, the interior of the hub 344 may be hollow to house a fan motor 310 therein. The blower 1 may further include a wire case in which a wire that supplies power to the fan motor 310 is disposed. The wire case 349 may extend in the radial direction between the rim 342 and the hub 344, and the wire case 349 may be disposed in the second area Vp2. Accordingly, the wire case 349 that is thicker than the vane 348 and protects the wire, which is inevitably provided for the operation of the fan motor 310, from moisture or water drops inside may be formed not in the first area Vp1 but in the second area Vp2 with a relatively wide flow path, thereby mitigating the reduction of flow efficiency due to the wire case 349.

For example, the wire case 349 may be disposed in the 2-3 area Vp23 as shown in the figure. Therefore, by disposing the wire case 349 in the 2-3 area Vp23, which exerts a relatively small effect on the discharge performance within the second areas Vp2, decrease in flow efficiency caused by the wire case 349 may be further alleviated.

Meanwhile, in the blower 1 structure in which the lower case 150, tower base 130, and upper case 140 are stacked from the lower side to the upper side, a structure supporting the load of the upper part of the blower 1 needs to be provided. In particular, since the first tower 110 and the second tower 120 are laterally separated from each other, the blower 1 may exhibit reduced resistance to external forces that widen or narrow the separation between the two towers.

Accordingly, the bridge surface 131 may connect the lower ends of the side walls of the first tower 110 and the second tower 120 facing each other with respect to the blowing space BS (see FIGS. 1, 5 to 7). The bridge surface 131 may be the upper surface of the tower base 130 described above. The bridge surface 131 may form a continuous surface with the inner wall (first inner wall) of the first tower. The bridge surface 131 may form a continuous surface with the inner wall (second inner wall) of the second tower. The bridge surface 131 may fix the first tower 110 and the second tower 120 and may receive the loads from the first tower 110 and the second tower 120.

The air that reaches the bridge surface 131 among the air discharged from the diffuser 340 and flowing in the distribution space Vd may travel on the bridge surface 131 to be distributed to the first tower 110 and the second tower 120. The bridge surface 131 may be formed as a downwardly protruding curved surface, facilitating smooth distribution of air flow.

The lower part of the supporter 370 is connected to the upper part of the hub 344, and the upper part of the supporter 370 is connected to the lower surface of the bridge surface 131; thus, the load may be transferred from the bridge surface 131 to the hub 344. The supporter 370 may be disposed between the diffuser 340 and the bridge surface 131 to connect the diffuser 340 and the bridge surface 131 (see FIGS. 5 to 7 and 13).

The connection between the lower part of the supporter 370 and the upper part of the hub 344 may include not only a direct connection but also a case where they are indirectly connected by disposing another structure in between.

The supporter 370 may have a predetermined pillar shape that transfers the load but does not disturb the flow inside the blower 1. For example, to evenly transfer the load to the hub 344, the planar cross-section of the lower end of the supporter 370 may correspond to the planar cross-section of the upper end of the hub 344. Also, the supporter 370 may have a cone shape or a truncated cone shape with a planar cross-section that tapers narrower toward the upper side to reduce the internal flow resistance of the blower 1.

Meanwhile, since all the loads of the inner walls of the first tower 110 and the second tower 120 are transferred to the hub 344 through the supporter 370, durability issues may occur for the hub 344. Accordingly, a plurality of vanes 348 may have their radial inner ends connected to the hub 344 and their radial outer ends connected to the rim 342. In other words, the plurality of vanes 348 not only simply partitions the pressurized space Vp but also connects the hub 344 and the rim 342, thereby allowing the load applied to the hub 344 to be distributed to the rim 342.

Therefore, in a structure requiring stable transfer of the load of the upper part of the blower 1 to the lower part of the blower 1, especially in a twin tower type blower 1 where the two towers are separated from each other, the load of the hub 344 may be distributed to the rim 342 by connecting the hub 344 and the rim 342 through the vane 348 of the diffuser 340 to guide an air flow while the load of the upper part of the blower 1 is transferred to the hub 344 of the diffuser 340; accordingly, the structural rigidity of the diffuser 340 may be enhanced.

Meanwhile, since an inwardly bent portion (recessed portion 346) is formed in the hub 344, the load of the upper part of the blower 1 may be concentrated on the bent portion. This is generally because more load is concentrated toward the center of the planar cross-section at which the center of gravity of the blower 1 is located; the inwardly bent portion of the hub 344 moves closer to the center of gravity of the blower 1 and thus receives a more concentrated load than the other parts.

In general, the blower 1 may have a shape whose interior is symmetrical with respect to the rotation axis of the fan 320 or the motor shaft 312 of the fan motor 310. Accordingly, the load applied from the upper part of the blower 1 to the hub 344 may be applied by being uniformly distributed on a virtual circumference drawn with respect to the central axis. Therefore, when the hub 344 is recessed inward to secure the width of the flow path of the diffuser 340, a problem may occur in which the recessed portion 346 bears the load concentrated on the corresponding circumference.

The blower 1 may further include a subcolumn 345 disposed inside the hub 344. The subcolumn 345 may be disposed on the same circumference CL as the recessed portion 346 with respect to the center of the hub 344 (see FIG. 15). Alternatively, the recessed portion 346 may be regarded as being formed to circumscribe the circumference CL formed by the subcolumn 345. The separation distance Dp2 of the second area Vp2 may also be determined in this way. Also, the degree to which the flow path width is widened may be determined differently by considering the size of the motor built into the hub 344, the shape of the flow path inside the blower 1, and so on.

Since the subcolumn 345 is disposed on the same circumference CL with the recessed portion 346, the subcolumn 345 and the recessed portion 346 may be separated by the same radius from the center of the hub 344 (or the center of gravity on the planar cross-section of the blower 1). Accordingly, the subcolumn 345 and the recessed portion 346 may share and bear the load applied from the upper part of the blower 1.

Therefore, since the subcolumn 345 disposed inside the hub 344 supports the load of the upper part of the blower 1 together with the recessed portion 346 of the hub 344 on the same circumference, the hub 344 may be prevented from being damaged as the load is concentrated on the recessed portion 346 of the hub 344, and the structural stability of the blower 1 may be improved.

The lower end of the subcolumn 345 may be connected to the second part 344b of the hub 344. The second part 344b of the hub 344 may support the lower end of the subcolumn 345. The subcolumn 345 may have a pillar shape with a length equivalent or similar to that of the first part 344a of the hub 344. The upper end of the subcolumn 345 may be connected to the lower part of the supporter 370.

The subcolumn 345 may be disposed to surround the outer periphery of the fan motor 310 to share the load as described above and, at the same time, to tightly fix the outer periphery of the fan motor 310. It is natural that fixing the fan motor 310 may lead to a reduction in the vibration and noise of the blower 1.

Referring to FIGS. 5 to 7, the blower 1 may include a filter 200 disposed inside the case 100.

The filter 200 may be disposed inside the lower case 150. The lower case 150 may be formed to be detachable and may provide a detachable path for the filter. The user may separate the lower case 150 and take the filter 200 out of the case 100.

The filter 200 may be formed in a cylindrical shape with a vertical hollow formed inside. The outer surface of the filter 200 may face the inlet 155. Indoor air may flow through the filter 200 from the outside to the inside; through the above process, foreign substances or harmful gases in the air may be removed.

Meanwhile, an inlet grille 350 may be disposed at the air inlet of the fan 320. The inlet grille 350 is used to prevent the user's fingers from entering the fan 320 when the filter 200 is separated, thereby protecting the user and the fan 320.

The filter 200 may be disposed in the lower side of the inlet grille 350, and the fan 320 may be disposed in the upper side. The inlet grille 350 has a plurality of through holes in the vertical direction to allow air to flow.

In what follows, with reference to FIGS. 1 to 4, 11, and 12, the outlet and the flow of discharged air will be described in detail.

The first outlet 117 and the second outlet 127 may be disposed within the height of the blowing space BS, and a direction crossing the blowing space BS may be defined as the air discharge direction. Since the first tower 110 and the second tower 120 are disposed on the left and right, the air discharge direction according to the present embodiment may be formed in the front-back and up-down directions.

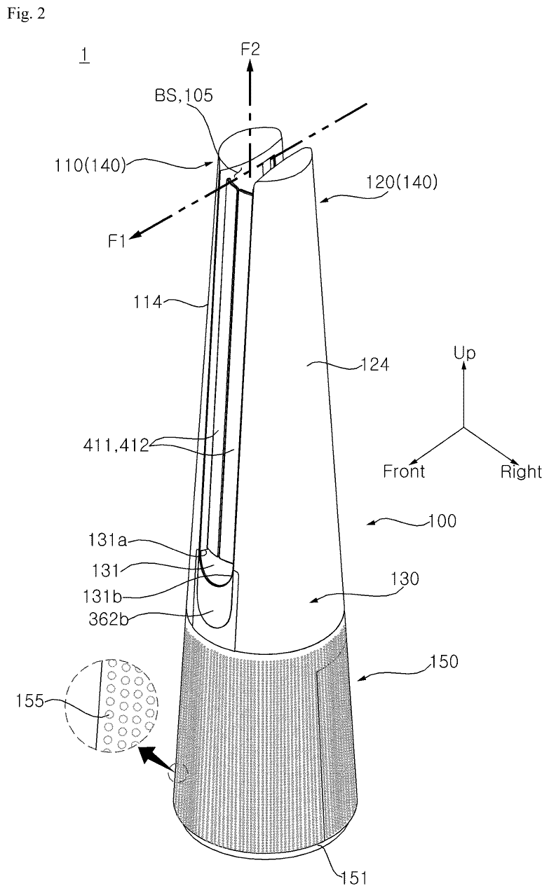

In other words, the air discharge direction across the blowing space BS may include a first air discharge direction F1 arranged in the horizontal direction and a second air discharge direction F2 formed in the vertical direction (See FIG. 2). The air flowing in the first air discharge direction F1 may be called a horizontal airflow, and the air flowing in the second air discharge direction F2 may be called an upward airflow.

The horizontal airflow should be understood that a greater amount of air flows in the horizontal direction rather than implying that air flows only in the horizontal direction. Likewise, the upward airflow should be understood that a greater amount of air flows in the upward direction rather than implying that air flows only in the upward direction.

In the present embodiment, the upper and lower intervals of the blowing space BS may be formed to be the same. Unlike the present embodiment, it is equally acceptable that the upper spacing of the blowing space BS may be narrower or wider than the lower spacing.

By making the left and right widths of the blowing space BS constant, a more uniform airflow may be formed in front of the blowing space BS.

For example, if the width of the upper side differs from the width of the lower side, the flow speed on the wider side may be formed to be low, and deviations in the flow speed may occur in the vertical direction. If deviations in the air flow speed occur in the vertical direction, the arrival distance of the air may vary accordingly.

The air discharged from the first outlet 117 and the second outlet 127 may join in the blowing space BS and then flow to the user.

In other words, in the present embodiment, the air discharged from the first outlet 117 and the air discharged from the second outlet 127 may be made not to individually flowed to the user, but the air discharged from the first outlet 117 and the air discharged from the second outlet 127 may be combined in the blowing space BS and then provided to the user.

The blowing space BS may be used as a space where discharged air is combined and mixed. Also, the air behind the blowing space BS may also flow into the blowing space BS by the air discharged into the blowing space BS.

By combining the discharged air from the first outlet 117 and the discharged air from the second outlet 127 in the blowing space BS, the straightness of flow of the discharged air may be improved. Also, by combining the discharged air from the first outlet 117 and the discharged air from the second outlet 127 in the blowing space BS, the air around the first tower 110 and the second tower 120 may also be directed toward the air discharge direction.

In this embodiment, the first air discharge direction F1 may be formed from the rear to the front, and the second air discharge direction F2 may be formed from the lower side to the upper side.

To form the second air discharge direction F2, the upper end 111 of the first tower 110 and the upper end 121 of the second tower 120 may be separated from each other. In other words, the upper part of the blowing space BS may be open. To form the first air discharge direction F1, the front end 112 of the first tower 110 and the front end 122 of the second tower 120 may be separated from each other. In other words, the front of the blowing space BS may be opened.

The rear end 113 of the first tower 110 and the rear end 123 of the second tower 120 may also be separated from each other. In other words, the rear of the blowing space BS may be opened. Accordingly, when the blower 1 operates, the airflow behind the blower 1 may flow into the rear of the blowing space BS due to the pressure difference.

In the first tower 110 and the second tower 120, the surface facing the blowing space BS may be referred to as an inner wall, and the surface not facing the blowing space BS may be referred to as an outer wall.

The outer wall 114 of the first tower 110 and the outer wall 124 of the second tower 120 may be disposed in opposite directions, and the inner wall 115 of the first tower 110 and the second tower 120 may be disposed to face each other.

If distinction between the inner walls 115, 125 is necessary, the inner wall of the first tower 110 may be referred to as the first inner wall 115, and the inner wall of the second tower 120 may be referred to as the second inner wall 125.

Likewise, if it is necessary to distinguish between the outer walls 114, 124, the outer wall of the first tower 110 may be referred to as the first outer wall 114, and the outer wall of the second tower 120 may be referred to as the second outer wall 124.

The first tower 110 and the second tower 120 may be formed in a streamlined shape along with the direction of air flow. Specifically, the first inner wall 115 and the first outer wall 114 may be formed in a streamlined shape in the front-to-back direction, and the second inner wall 125 and the second outer wall 124 may be formed in a streamlined shape in the front-to-back direction.

The first outlet 117 may be disposed on the first inner wall 115, and the second outlet 127 may be disposed on the second inner wall 125.

The shortest distance between the first inner wall 115 and the second inner wall 125 is referred to as B0. The output 117, 127 may be located in the rear beyond the shortest distance B0.

The separation distance between the front end 112 of the first tower 110 and the front end 122 of the second tower 120 may be referred to as the first separation distance B1, and the separation distance between the rear end 113 of the first tower 110 and the rear end 123 of the second tower 120 may be referred to as the second separation distance B2.

In the present embodiment, B1 and B2 may be formed to be identical. Unlike the present embodiment, it is also acceptable that either B1 or B2 may be formed to be longer than the other.

The first outlet 117 and the second outlet 127 may be disposed between B0 and B2.

It is preferable that the first outlet 117 and the second outlet 127 are disposed being closer to the rear end 113 of the first tower 110 and the rear end 123 of the second tower 120 than to B0. The closer the outlet 117, 127 is located to the rear end 113, 123, the more easily airflow may be controlled through the Coanda effect, which will be described later.

The inner wall 115 of the first tower 110 and the inner wall 125 of the second tower 120 may directly provide the Coanda effect, and the outer wall 114 of the first tower 110 and the outer wall 124 of the second tower 120 may indirectly provide the Coanda effect.

The inner wall 115, 125 may directly guide the air discharged from the outlet 117, 127 to the front end 112, 122.

In other words, the air discharged from the outlet 117, 127 may be directly provided as a horizontal airflow.

Indirect air flow may also occur in the outer wall 114, 124 due to air flow in the blowing space BS.

The outer wall 114, 124 may cause the Coanda effect for indirect air flow and direct the indirect air flow to the front end 112, 122.

The left side of the blowing space BS may be blocked by the first inner wall 115, and the right side of the blowing space BS may be blocked by the second inner wall 125, while the upper side of the blowing space BS may be open.

An air flow converter described later may convert the horizontal airflow passing through the blowing space BS into an upward airflow, and the upward airflow may flow to the open upper side of the blowing space BS. The upward airflow may prevent the discharged air from flowing directly to the user while facilitating active convection of indoor air.

Also, the width of the discharged air may be adjusted through the flow rate of the air combined in the blowing space BS.

By forming the vertical length of the first outlet 117 and the second outlet 127 to be much longer than the left and right widths B0, B1, B2 of the blowing space BS, the discharged air from the first outlet 117 and the discharged air from the second outlet 127 may be induced to merge in the blowing space BS.

In what follows, the overall shape of the blower 1 will be described with reference to FIGS. 1 to 4.

The blower 1 may have a pillar shape whose diameter becomes smaller as it moves upward. The blower 1 may have a cone or truncated cone shape overall. In the present embodiment, the diameter of the lower case 150 may gradually decrease as it moves toward the upper end. The tower base 130 may be formed to have a diameter gradually decreasing as it moves toward the upper end. The upper case 140 may also have a diameter gradually decreasing as it moves toward the upper end.

Unlike the present embodiment, the blower 1 may include both configurations in which two towers are disposed. Also, unlike the present embodiment, it is acceptable that the cross section does not taper as it moves toward the upper side.

However, when the cross-section tapers as it moves toward upper side as in the present embodiment, an advantageous effect is obtained in that the center of gravity is lowered and the risk of overturning due to and external impact is reduced. Also, for the type of blower 1 having an outlet extending in the vertical direction, each portion of the outlet may have the same discharge pressure regardless of variations in length from the fan 320 to each part of the outlet.

Unlike the present embodiment, it is acceptable that the lower case 150, tower base 130, and upper case 140 are combined into a single integrated unit. For example, after the front case 100 and the rear case 100 are manufactured in an integrated unit, the lower case 150, tower base 130, and upper case 140 may be assembled.

The outer surfaces of the lower case 150, tower base 130, and upper case 140 may be formed to be continuous. In particular, the lower end of the tower base 130 and the upper end of the lower case 150 may be in close contact, and the outer surface of the tower base 130 and the outer surface of the lower case 150 may form a continuous surface. To this end, the diameter of the lower end of the tower base 130 may be formed to be equal to or slightly smaller than the diameter of the upper end of the lower case 150.

The lower case 150 may form an internal space, and an inlet 155 may be formed on the periphery. The lower case 150 may further include a base 151 seated on the ground. The lower case 150 is formed to be detachable in the lateral direction, thereby providing a path for detaching a filter. In the present embodiment, the inlet 155 may be formed along the periphery of the lower case 150 and may draw air from all directions of 360 degrees. In the present embodiment, the inlet 155 may be formed in the shape of a hole; the shape of the inlet 155 may be formed in various ways.

The tower base 130 may distribute air supplied from the lower case 150 and provide the distributed air to the first tower 110 and the second tower 120. The tower base 130 may connect the first tower 110 and the second tower 120, and the blowing space BS may be disposed on the upper side of the tower base 130. Also, the outlet 117, 127 may be disposed on the upper side of the tower base 130, and upward airflow and horizontal airflow may be formed on the upper side of the tower base 130.

To minimize friction with air, the upper side surface 131 of the tower base 130 may be formed as a curved surface. In particular, the upper side surface may be formed as a downwardly concave curved surface and may be formed to extend in the front-back direction. One side 131a of the upper side surface 131 may be connected to the first inner wall 115, and the other side 131b of the upper side surface 131 may be connected to the second inner wall 125. The upper side surface 131 may form a continuous surface with the first inner wall 115 and the second inner wall 125. The upper side surface 131 of the tower base 130 may be referred to as a bridge surface 131.

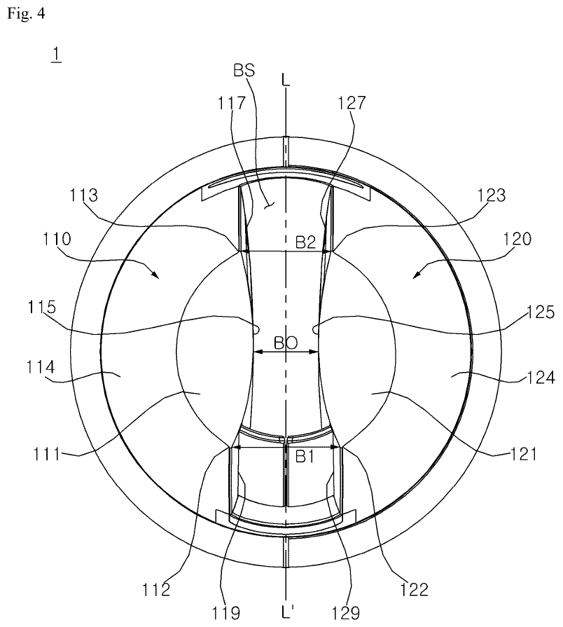

Referring to FIG. 4, when viewed from the top, the first tower 110 and the second tower 120 may exhibit bilateral symmetry relative to the center line L-L′. In particular, the first outlet 117 and the second outlet 127 may be disposed symmetrically on the left and right sides relative to the center line L-L′.

The center line L-L′ is an imaginary line between the first tower 110 and the second tower 120 and may be disposed in the front-back direction in the present embodiment; the center line L-L′ may also be disposed to pass through the upper side surface 131.

Unlike the present embodiment, it is acceptable that the first tower 110 and the second tower 120 are formed in an asymmetric shape. However, it is more advantageous to dispose the first tower 110 and the second tower 120 to be symmetrical relative to the center line L-L′ for controlling horizontal and upward airflows.

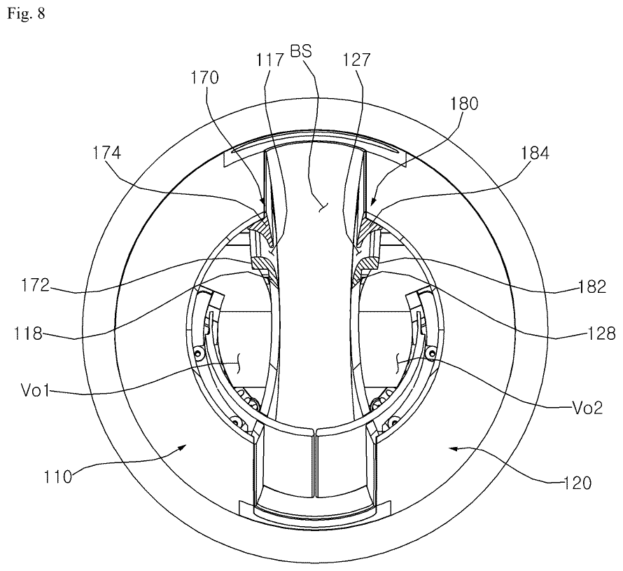

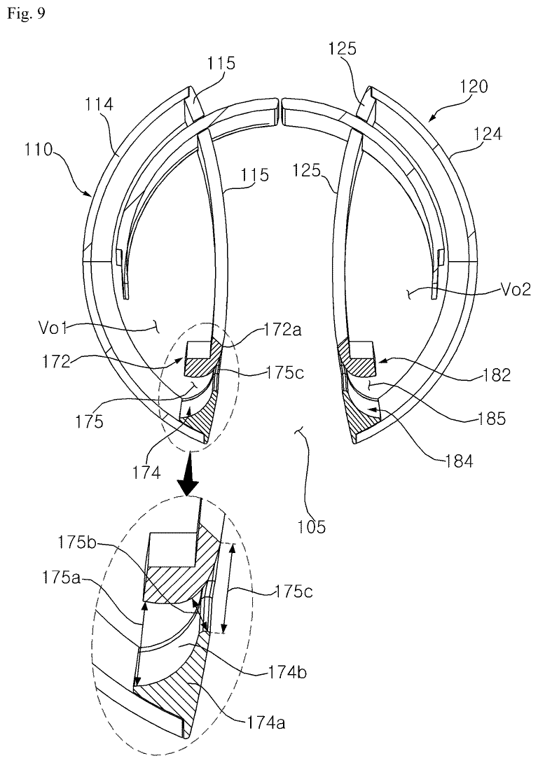

Referring to FIGS. 8 and 9, the first outlet 117 of the first tower 110 may be disposed to face the second tower 120, and the second outlet 127 of the second tower 120 may face the first tower 110.

The air discharged from the first outlet 117 may cause the air to flow along the inner wall 115 of the first tower 110 through the Coanda effect. The air discharged from the second outlet 127 may cause the air to flow along the inner wall 125 of the second tower 120 through the Coanda effect.

Unlike the descriptions above, the first outlet 117 and the second outlet 127 may be formed by disposing discharge parts, which are separate members to be described later, to the openings 118, 128 of the first tower 110 and the second tower 120.

The first discharge part 170 may form a first outlet 117; the first discharge part 170 may form the first outlet 117 with a first discharge guide 172 disposed on the air discharge side of the first outlet 117; and the first discharge part 170 may include a second discharge guide 174 disposed on the opposite side of the first outlet 117 from which air is discharged.

The outer surfaces 172a, 174a of the first discharge guide 172 and the second discharge guide 174 may provide a portion of the inner wall 115 of the first tower 110.

The inside of the first discharge guide 172 may be disposed toward the first discharge space Vo1, and the outside thereof may be disposed toward the blowing space BS. The inside of the second discharge guide 174 may be disposed toward the first discharge space Vo1, and the outside thereof may be disposed toward the blowing space BS.

The outer surface 172a of the first discharge guide 172 may be formed as a curved surface. The outer surface 172a may provide a continuous surface with the first inner wall 115. In particular, the outer surface 172a forms a curved surface that is continuous with the outer surface of the first inner wall 115.

The outer surface 174a of the second discharge guide 174 may provide a continuous surface with the first inner wall 115. The inner surface 174b of the second discharge guide 174 may be formed as a curved surface. In particular, the inner surface 174b may form a curved surface continuous with the inner surface of the first outer wall 115, through which the air in the first discharge space Vo1 may be directed toward the first discharge guide 172.

The first outlet 117 may be formed between the first discharge guide 172 and the second discharge guide 174, and the air in the first discharge space Vo1 may pass through the first outlet 117 to be discharged into the blowing space BS.

Specifically, the air in the first discharge space Vo1 may be discharged between the outer surface 172a of the first discharge guide 172 and the inner surface 174b of the second discharge guide 174, and a discharge gap 175 is defined as the space between the outer surface 172a of the discharge guide 172 and the inner surface 174b of the second discharge guide 174. The discharge interval 175 may be a predetermined channel.

The discharge interval 175 may be formed so that the width of the middle portion 175b is narrower than that of the entrance 175a and the exit 175c. The middle portion 175b is defined as the shortest distance among the discharge intervals 175.

The cross-sectional area may taper gradually from the entrance to the middle portion 175b of the discharge interval 175 and then widen again from the middle portion 175b to the exit 175c. The middle portion 175b may be located inside the first tower 110. When viewed from the outside, the exit 175c of the discharge interval 175 may appear as the outlet 117.

To induce the Coanda effect, the radius of curvature of the inner surface 174b of the second discharge guide 174 may be formed to be larger than the radius of curvature of the outer surface 172a of the first discharge guide 172.

The center of curvature of the outer surface 172a of the first discharge guide 172 may be located ahead of the outer surface 172a and may be formed inside the first discharge space Vo1. The center of curvature of the inner surface 174b of the second discharge guide 174 may be located on the side of the first discharge guide 172 and may be formed inside the first discharge space Vo1.

The second discharge part 180 may form a second outlet 127; the second discharge part 180 may form the second outlet 127 with a second discharge guide 182 disposed on the air discharge side of the second outlet 127; and the second discharge part 180 may include a second discharge guide 184 disposed on the opposite side of the second outlet 127 from which air is discharged.

A discharge gap 185 may be formed between the first discharge guide 182 and the second discharge guide 184. Since the second discharge part 180 exhibits bilateral symmetry with the first discharge part 170, detailed descriptions will be omitted.

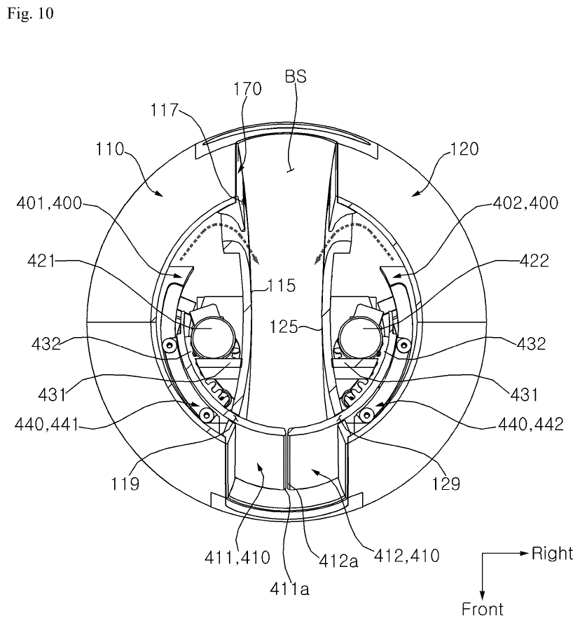

An air flow converter 400 capable of forming an upward airflow will be described with reference to FIGS. 10 to 12. The blower 1 may further include an air flow converter 400 that changes the air flow direction of the blowing space BS.

In the present embodiment, the air flow converter 400 may convert the horizontal airflow flowing through the blowing space BS into an upward airflow.

The air flow converter 400 may include a first air flow converter 401 disposed in the first tower 110 and a second air flow converter 402 disposed in the second tower 120. The first air flow converter 401 and the second air flow converter 402 exhibit bilateral symmetry and have the same configuration.

The air flow converter 400 may be disposed on the tower and may include a guide board 410 that protrudes into the blowing space BS, a guide motor 420 that provides a driving force for movement of the guide board 410, a power transmission member 430 that provides the driving force of the guide motor 420 to the guide board 410, and a board guider 440 disposed inside the tower and guiding the movement of the guide board 410.

The guide board 410 may be concealed inside the tower and may protrude into the blowing space BS when the guide motor 420 operates.

In the present embodiment, the guide board 410 may include a first guide board 411 disposed in the first tower 110 and a second guide board 412 disposed in the second tower 120.

To this end, a board slit 119 penetrating the inner wall 115 of the first tower 110 may be formed, and a board slit 129 penetrating the inner wall 125 of the second tower 120 may be formed respectively.

The board slit 119 formed in the first tower 110 is called the first board slit 119, and the board slit formed in the second tower 120 is called the second board slit 129.

The first board slit 119 and the second board slit 129 may be arranged to form bilateral symmetry. The first board slit 119 and the second board slit 129 may be formed to extend in the vertical direction. The first board slit 119 and the second board slit 129 may be disposed at an angle with respect to the vertical direction V.

The front end 112 of the first tower 110 may be formed at a first inclination when the vertical direction is set to 0 degrees, and the first board slit 119 may be formed at a second slope. The front end 122 of the second tower 120 may also be formed at the first slope, and the second board slit 129 may be formed at the second slope.

The first slope may be formed between the vertical direction and the second slope, and the second slope may be larger than the horizontal direction. The first slope and the second slope may be the same, or the second slope may be greater than the first slope.

The guide board 410 may be formed in a flat or curved plate shape. The guide board 410 may be formed to extend in the vertical direction and may be disposed in front of the blowing space BS.

The guide board 410 may block the horizontal airflow flowing into the blowing space BS and redirect the horizontal airflow upward.

In the present embodiment, the inner end 411a of the first guide board 411 and the inner end 412a of the second guide board 412 may come into contact or be in close contact with each other to form an upward airflow. Unlike the present embodiment, one guide board 410 may be in close contact with the opposite tower to form an upward airflow.

When the air flow converter 400 is not in operation, the inner end 411a of the first guide board 411 may close the first board slit 119, and the inner end 412a of the second guide board 412 may close the second board slit 129.

When the air flow converter 400 is in operation, the inner end 411a of the first guide board 411 may protrude into the blowing space BS through the first board slit 119, and the second guide board 411 may protrude into the blowing space BS. The inner end 412a of the guide board 412 may protrude into the blowing space BS through the second board slit 129.

In the present embodiment, the first guide board 411 and the second guide board 412 may protrude into the blowing space BS through a rotational motion. Unlike the present embodiment, at least one of the first guide board 411 and the second guide board 412 may move linearly in a sliding manner and protrude into the blowing space BS.

When viewed from the top, the first guide board 411 and the second guide board 412 may be formed in an arc shape. The first guide board 411 and the second guide board 412 may form a predetermined radius of curvature, and the center of curvature may be located in the blowing space BS.

When the guide board 410 is concealed inside the tower, it is preferable that the inner radial volume of the guide board 410 to be larger than its outer radial volume.

The guide board 410 may be made of a transparent material. A light-emitting member such as an LED may be disposed on the guide board 410, and the entire guide board 410 may be made to emit light through the light generated from the light-emitting member. The light emitting member may be disposed in the discharge space Vo inside the tower and may be disposed on the outer end of the guide board 410.

The guide motor 420 may include a first guide motor 421 that provides a rotational force to the first guide board 411, and a second guide motor 422 that provides a rotational force to the second guide board 412.

The first guide motor 421 may be disposed on both the upper and lower sides within the first tower 110 and if differentiation is required, the first guide motor 421 may be distinguished by referring to it as the upper first guide motor 421 or the lower first guide motor 421. The upper first guide motor may be disposed below the upper end 111 of the first tower 110, and the lower first guide motor may be disposed above the fan 320.

The second guide motor 422 may also be disposed on both the upper and lower sides within the second tower 120, and if differentiation is required, the second guide motor 422 may be distinguished by referring to it as the upper second guide motor 422a or the lower second guide motor 422b. The upper second guide motor may be disposed below the upper end 121 of the second tower 120, and the lower second guide motor may be disposed above the fan 320.

In the present embodiment, the rotation axes of the first guide motor 421 and the second guide motor 422 may be disposed in the vertical direction, and a rack-pinion structure may be used to transmit the driving force.

The power transmission member 430 may include a drive gear 431 coupled to the motor shaft 312 of the guide motor 420 and a rack 432 coupled to the guide board 410.

The drive gear 431 may use a pinion gear and may rotate in the horizontal direction.

The rack 432 may be coupled to the inner side surface of the guide board 410. The rack 432 may be disposed in the discharge space Vo and may make a turning movement together with the guide board 410.

The board guider 440 may guide the turning movement of the guide board 410. The board guider 440 may support the guide board 410 during the turning movement of the guide board 410.

In the present embodiment, the board guider 440 may be disposed on the opposite side of the rack 432 with respect to the guide board 410. The board guider 440 may support the force applied from the rack 432. Unlike the present embodiment, a groove corresponding to the turning radius of the guide board may be formed in the board guider 440, and the guide board may be moved along the groove.

The board guider 440 may be assembled on the outer wall 114, 124 of the tower. The board guider 440 may be disposed radially on the outer side with respect to the guide board 410, thereby minimizing contact with air flowing in the discharge space Vo.

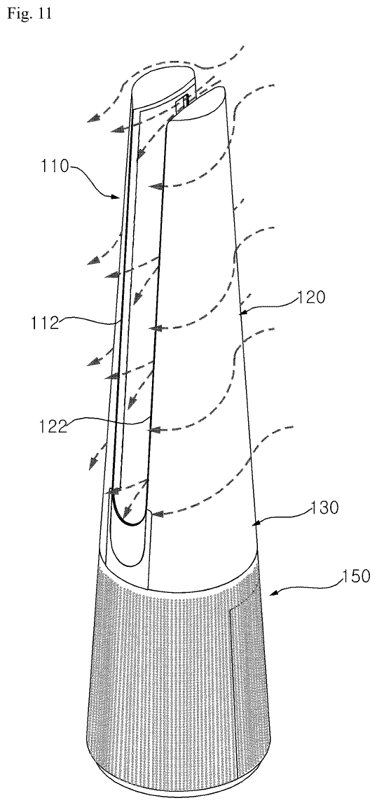

FIG. 11 is an exemplary diagram showing the horizontal airflow of the blower 1 according to an embodiment of the present disclosure.

Referring to FIG. 11, when providing a horizontal airflow, the first guide board 411 may be concealed inside the first tower 110, and the second guide board 412 may be concealed inside the second tower 120.

The discharged air from the first outlet 117 and the discharged air from the second outlet 127 may be combined in the blowing space BS 120 and may flow forward through the front end 112, 122.

Moreover, the air in the rear of the blowing space BS may be induced into the blowing space BS and then flow forward.

Also, the air around the first tower 110 may flow forward along the first outer wall 114, and the air around the second tower 120 may flow forward along the second outer wall 124.

Since the first outlet 117 and the second outlet 127 are formed to extend in the vertical direction and are disposed to form the bilateral symmetry, the air flowing from the upper side of the first outlet 117 and the second outlet 127 and the air flowing from the lower side may be formed more uniformly.

Also, since the air discharged from the first outlet 117 and the second outlet 127 joins in the blowing space BS, the straightness of flow of the discharged air may be improved, and the air may flow to a greater distance.

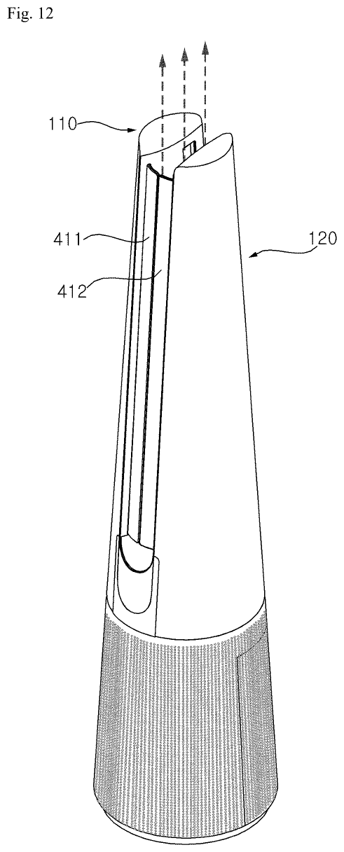

FIG. 12 is an exemplary diagram showing the upward airflow of the blower 1 according to an embodiment of the present disclosure.

Referring to FIG. 12, when providing an upward airflow, the first guide board 411 and the second guide board 412 may protrude into the blowing space BS and block the front of the blowing space BS.

As the front of the blowing space BS is blocked by the first guide board 411 and the second guide board 412, the air discharged from the outlet 117, 127 may rise along the rear surfaces of the first guide board 411 and the second guide board 412 and be discharged to the upper part of the blowing space BS.

By forming an upward airflow in the blower 1, the discharged air may be prevented from flowing directly toward the user. Also, when it is desired to circulate indoor air, the blower 1 may be operated using the upward airflow.

For example, when using an air conditioner and the blower 1 at the same time, convection of indoor air may be facilitated by operating the blower 1 using the upward air flow, and the indoor air may be cooled or heated more quickly.

It should be understood by those skilled in the art to which the present disclosure belongs that the present disclosure may be embodied in other specific forms without changing the technical principles or essential characteristics of the present disclosure. Therefore, the embodiments described above should be regarded as being illustrative rather than restrictive in every aspect. The technical scope of the present disclosure should be determined by the appended claims given below rather than by detailed descriptions, and it should be understood that all changes or modified forms derived from the meaning and the scope of the appended claims and their equivalent concepts should be interpreted as being included in the scope of the present disclosure.

1-16. (canceled)

17. A blower comprising:
a lower case, the lower case including an inlet;
an upper case located above the lower case; the upper case including an outlet; and
a fan assembly located in the lower case, the fan assembly being configured to pressurize air introduced through the inlet and direct the pressurized air toward the outlet, the fan assembly including:
a rim;
a fan located inside the rim, the fan having a plurality of blades configured to rotate around a vertical rotation axis;
a hub located above the fan inside the rim, the hub being spaced inward from an inner peripheral surface of the rim along a radial direction to define a space through which air discharged from the fan flows, the space including a first area having a first separation distance between the rim and the hub and a second area having a second separation distance between the rim and the hub, the second separation distance being larger than the first separation distance;
a plurality of vanes extending in a radial direction to connect the rim and the hub, the plurality vanes including:
a first vane located in the first area, the first vane having a first entrance angle; and
a second vane located in the second area, the second vane having a second entrance angle larger than the first entrance angle.

18. The blower of claim 17, wherein the first entrance angle and the second entrance angle are defined by a degree of inclination of a lower end portion of the first vane and the second vane, respectively, with respect to a vertical direction.

19. The blower of claim 17, wherein the outlet of the upper case includes a first outlet and a second outlet, and
wherein the upper case further includes:
a first tower, the first tower having the first outlet and a first discharge space configured to receive air discharged from the fan;
a second tower spaced from the first tower, the second tower having the second outlet and a second discharge space configured to receive air discharged from the fan.

20. The blower of claim 19, further comprising a tower base located between the upper case and the lower case, the tower base defining a distribution space configured to receive air discharged from the fan and to distribute the air to the first discharge space and the second discharge space.

21. The blower of claim 20, wherein the second area of the space between the rim and the hub is located below the first discharge space and the second discharge space.

22. The blower of claim 21, wherein the first tower and the second tower are symmetrical to each other, and
wherein the second area includes a second-first area corresponding to the first discharge space and a second-second area corresponding to the second discharge space, the second-first area and the second-second area being symmetrical to each other.

23. The blower of claim 22, wherein the second vane includes a second-first vane located in the second-first area and a second-second vane located in the second-second area, the second-first vane and the second-second vane being symmetrical to each other.

24. The blower of claim 20, wherein a portion of a periphery of the tower base protrudes inward,
wherein a first structure is located at the portion of the periphery of the tower base; and
wherein the second area of the space between the rim and the hub is located above the first structure.

25. The blower of claim 24, wherein the first structure is a handle of the blower.

26. The blower of claim 17, wherein the rim is ring shaped,
wherein the hub is ring shaped, and
wherein a portion of a periphery of the hub includes a recessed portion recessed inward along the radial direction to define the second area between the rim and the portion of the periphery of the hub.

27. The blower of claim 26, wherein the recessed portion in the hub has a planar shape.

28. The blower of claim 17, wherein, in the plurality of vanes, a separation distance between adjacent vanes located in the second area is greater than a separation distance between adjacent vanes in the first area.

29. The blower of claim 17, wherein the fan assembly further comprises a fan motor configured to rotate the fan, and
wherein an interior of the hub is hollow, the fan motor being located in the interior of the hub.

30. The blower of claim 29, further comprising a wire configured to supply power to the fan motor,
wherein the fan assembly further includes a wire case extending in the radial direction between the rim and the hub in the second area, the wire being located in the wire case.

31. The blower of claim 17, wherein a portion of a periphery of the rim protrudes inward,
wherein a second structure is located at the portion of the periphery of the rim; and
wherein the first area of the space between the rim and the hub includes:
a first-first area; and
a first-second area, the portion of the periphery of the rim being located at the first-second area such that the separation distance between the rim and the hub in the first-first area is greater than the separation distance between the rim and the hub in the first-second area, and
wherein the first vane includes:
a first-first vane located in the first-first area; and
a first-second vane located in the first-second area, the entrance angle of the first-second vane being smaller than the entrance angle of the first-first vane.

32. The blower of claim 17, wherein a lower end of the second vane is bent and extended to define the entrance angle of the second vane, and
wherein a length of the lower end of the second vane is longer than a length of a lower end of the first vane.

33. The blower of claim 17, wherein the second vane is configured to be rotatable relative to the first vane such the entrance angle of the second vane is adjustable.

34. The blower of claim 17, wherein a width of the second area is 1.1 to 1.3 times wider than a width of the first area, and
wherein the entrance angle of the second vane is 2 to 4 degrees larger than the entrance angle of the first vane.

35. The blower of claim 17, wherein a size of the second area is 1% to 3% larger than a size of the first area, and
wherein the entrance angle of the second vane is 2 to 4 degrees larger than the entrance angle of the first vane.

36. The blower of claim 35, wherein the size of the second area is 2.5% larger than the size of the first area, and
wherein the entrance angle of the second vane is 3 degrees larger than the entrance angle of the first vane.
